(19) United States
(12) Patent Application Publication
(10) Pub. No.: US 2026/0349070 A1
(43) Pub. Date: Nov. 5, 2026

(54) Acoustic radar and System of acoustic detection and recognition of air targets using "Acoustic Radar" and special software with artificial intelligence - SDRAT

(71) Applicant: Ruslan Prysiazhnyi, Orlando, FL (US)

(72) Inventor: Ruslan Prysiazhnyi, Orlando, FL (US)

(21) Appl. No.: 19/198,005

(22) Filed: May 3, 2025

(51) Int. Cl. G01S 5/20

(52) U.S. Cl. CPC G01S 5/20

(57) ABSTRACT

An acoustic device for detecting, recognizing, and localizing airborne targets is disclosed. The system includes a densely packed directional microphone array containing hundreds of microphones arranged on a circular planar array up to one meter in diameter. Each microphone signal is digitized and processed by a central computing module configured to apply precomputed frequency-dependent amplification coefficients that form highly directional radiation patterns with minimized sidelobes. This provides substantial suppression of acoustic noise and increases detection range. The processor performs parallel spectral analysis of all microphone channels, applies optimized beamforming, and executes a self-learning neural-network algorithm to classify airborne targets and determine their parameters, including azimuth, elevation, velocity projection, and associated derivatives. The device operates passively, supports wired or wireless communication with external systems, and can integrate into air-defense architectures for real-time target tracking and parameter transmission.

Provisional Application #63/642,842—May 5, 2024

The invention pertains to acoustic signal processing devices, computing technology, and information transmission/processing systems. It is designed for airspace control through acoustic detection, recognition, and localization of airborne targets.

Radar systems are widely used for airspace control, detecting airborne targets through signals reflected from the object after exposure to electromagnetic waves. However, these systems are costly and complex to manufacture. They struggle with detecting small-sized targets, low-altitude targets, radio-transparent targets (i.e., targets with zero effective reflecting surface for classical radar signals), and targets obscured by obstacles, including natural ones. Additionally, radar systems operate in an active emission mode, making them easily detectable and vulnerable, posing risks to military personnel operating them. Therefore, in many cases, detecting, recognizing, and localizing airborne targets—especially those flying at low altitudes and using terrain for concealment—is advisable through acoustic signal processing systems. These systems operate in passive mode and can detect targets hidden behind natural obstacles. However, the successful application of such acoustic signal processing devices requires reliable and rapid identification of acoustic signals across a broad spectrum of target types.

A method for determining the direction to a sound-generating target and the range for engagement, along with a device for its implementation, is described in U.S. Pat. No. 5,161,127. This method employs a sensitive device consisting of multiple sensors, including acoustic sensors for determining the target's direction, particularly its bearing angle. The device typically includes three microphones arranged in an equilateral triangle and may also utilize seismic sensors.

Another known passive acoustic probing system, described in U.S. Pat. No. 9,651,649, includes at least one cluster of acoustic sensors connected to a computing device. This computing device is configured to process received acoustic signals and perform at least one of the following actions: detecting the presence of an acoustic source, determining the direction of arrival of the acoustic wave emitted by the source, and classifying the source based on its nature. The cluster may include at least two sensors, and the computing device may process signals to localize the acoustic source in three dimensions. The cluster may also include at least one seismic wave sensor.

These solutions' draw backs include relatively low accuracy in determining target parameters due to the limited number of acoustic sensors, low sensitivity, suboptimal signal-to-noise ratio, and restricted computational capabilities.

The closest analog to the proposed invention is an acoustic detection, recognition, and localization system for airborne targets, described in U.S. Pat. No. 7,952,513. It comprises:
a radar system for detecting targets based on radar signals;
an acoustic system for detecting targets based on acoustic signals, including a directional microphone array configured to receive and convert acoustic signals emitted by potential airborne targets into electrical signals. The system consists of a microphone array with a predefined spatial arrangement, digital conversion modules connected to the microphone array to transform electrical signals into digital signals, and a central computing module. This computing module processes the data, classifies acoustic signals received by the directional microphone array according to target types, and determines airborne target parameters for external consumers.

However, this existing solution has certain disadvantages, including suboptimal design and operational algorithms, resulting in relatively low sensitivity, the presence of sidelobes in the microphone array's radiation patterns (which reduces target detection reliability and increases false positives), and a limited detection range.

The objective of the proposed invention is to develop an acoustic detection, recognition, and localization device that increases the detection range of airborne targets, enhances resistance to acoustic interference/noise, improves reliability in target detection, and minimizes false positives.

The stated objective is achieved by developing an acoustic detection and recognition device for airborne targets, which includes at least one directional microphone array configured to receive acoustic signals emitted by potential airborne targets and convert them into electrical signals. This array consists of a set of microphones arranged in a predefined spatial configuration. Connected to the microphones of the directional microphone array are digital conversion modules designed to receive electrical signals and convert them into digital signals. Additionally, the device comprises a central computing module capable of receiving data from the digital conversion modules. This module contains at least one processor configured to process the received data, classify the acoustic signals captured by the directional microphone array according to airborne target types, and determine the parameters of airborne targets for external consumers. Furthermore, for data processing, at least one processor of the central computing module is additionally configured to utilize a precomputed array of amplification coefficients for each microphone in the directional microphone array and for each frequency or frequency interval.

The amplification coefficients can generally have both positive and negative values.

In the preferred implementation of the claimed invention, at least one processor of the central computing module is additionally configured to implement a self-learning neural network algorithm for processing the received data. The neural network simultaneously analyzes data from all microphones of the directional microphone array and detects the type and model (or group of models) of targets or determines the absence of airborne targets. This includes recognizing suspicious data as belonging to acoustic interference, followed by updating its data library with newly received information, or identifying such data as phantom signals and subsequently ignoring them.

The directional microphone array typically contains between 16 and 65,535 microphones. Most preferably, the directional microphone array contains 248 microphones.

The microphones that are part of the directional microphone array are typically equipped with miniature preamplifiers, which are implemented in the form of printed circuit boards and mounted on or within supports. These supports are connected to a horizontal mounting plate. The space between the microphones may be filled with noise-absorbing material. The cables connecting a microphone or a group of microphones to the digital conversion modules are shielded.

A possible implementation of the claimed invention includes a digital conversion module (housed in an enclosure with installed printed circuit boards) located beneath the horizontal mounting plate and featuring a digital output port.

A nother possible implementation of the claimed invention allows the digital conversion module to be integrated with the preamplifiers and the microphones themselves for certain densely arranged microphones of the directional microphone array, with the module positioned above the horizontal mounting plate.

The digital conversion modules are preferably connected via communication cables to a hub, which is further connected to the central computing module through a communication cable. The hub and the central computing module are either located beneath the horizontal mounting plate or positioned remotely at a distance limited by the type of interface, data transmission speed, and communication cable type.

The central computing module, as it receives data blocks, stores them in an array in the operational memory in chronological order.

The processor of the central computing module is configured to utilize mathematical algorithms optimized for linear algebra hardware by performing parallel multiprocessor computations. This, in turn, enables the execution of the Fourier transform for each data stream corresponding to each microphone of the directional microphone array.

The configuration of the processor in the central computing module, which utilizes a precomputed array of amplification coefficients for each microphone of the directional microphone array and each frequency or frequency interval, allows for the optimization of the radiation patterns of the microphone array. These patterns are formed for the further determination of airborne target parameters in such a way as to correspond to different azimuthal and vertical angles while ensuring radiation patterns with absent or minimized sidelobes (at a level of −50 dB). The absence of sidelobes in the radiation patterns directly enhances resistance to acoustic interference/noise, thereby improving the accuracy of target detection and minimizing false positives while increasing the target detection range. Indeed, the presence of sidelobes indicates the presence of noise interference that may come from external directions. In addition to minimizing sidelobes in the radiation patterns of the microphone array, the described structural implementation of the claimed invention also enables the minimization of the main lobe size in the radiation pattern. The narrower the main lobe of the radiation pattern, the more directional the microphone array becomes, which allows for an increase in the potential target detection range in direct proportion to the reduction of the main lobe sector.

In another preferred embodiment of the invention, the microphones of the directional microphone array are arranged in a radially symmetric pattern within a circle with a diameter of 1 meter. The shape of the radiation pattern allows for the elimination of 9/10 of all existing noise interference, which is equivalent to increasing the potential target detection range more than 3 times due to the directivity effect. Regardless of where the claimed device is installed, it will be located in an environment with acoustic noise, which, in the form of acoustic signals, will affect the directional microphone array from all directions. This includes noise from leaves, birds, vehicles, railways, gunfire, explosions, and more. For easier understanding, the radiation pattern can be considered in its projection onto a horizontal plane: in this case, the area of the entire circle represents the level of noise from all directions, while the lobe of the radiation pattern covers approximately 1/10 of the area of this circle. In this way, 90% of all acoustic interference is effectively reduced to near zero. Thus, under otherwise equal conditions, the total noise level in the target direction will be \sqrt{10} times lower, meaning that the signal-to-noise ratio will improve by a factor of \sqrt{10}≈3.2 at the same detection range. Alternatively, the signal-to-noise ratio will remain unchanged if the target detection range is increased \sqrt{10} times.

The device is preferably designed to support wired or wireless communication with at least one external consumer of the determined airborne target parameters. The external consumer may be a central server containing at least one processor configured to generate targeting data based on the received airborne target parameters and subsequently transmit them to an air defense system. Another possible implementation of the invention allows the external consumer to be the air defense system itself.

In the preferred implementation of the claimed invention, the parameters of airborne targets are selected from a group that includes the type and model of the target; azimuth angle and its derivative; vertical angle and its derivative; the projection of the target's velocity onto the axis passing through the target's position and the device, along with its derivative; a timestamp accounting for the delay in data acquisition and processing; wind speed and direction at the device's installation location; and error estimation for each determined parameter.

The claimed invention will be further described in detail with the following graphical materials:

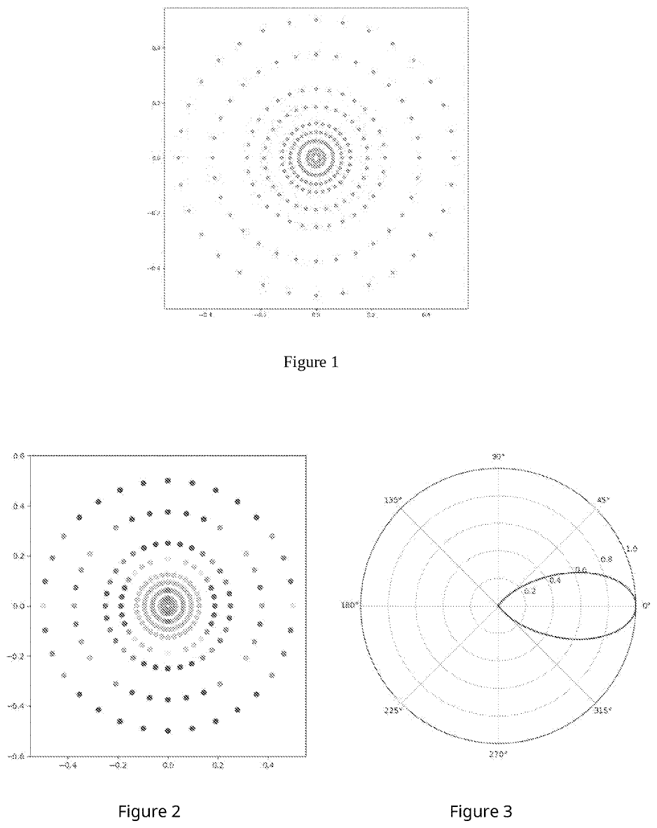

FIG. 1—a schematic representation of an example arrangement of microphones in the directional microphone array of the acoustic detection, recognition, and localization device for airborne targets;

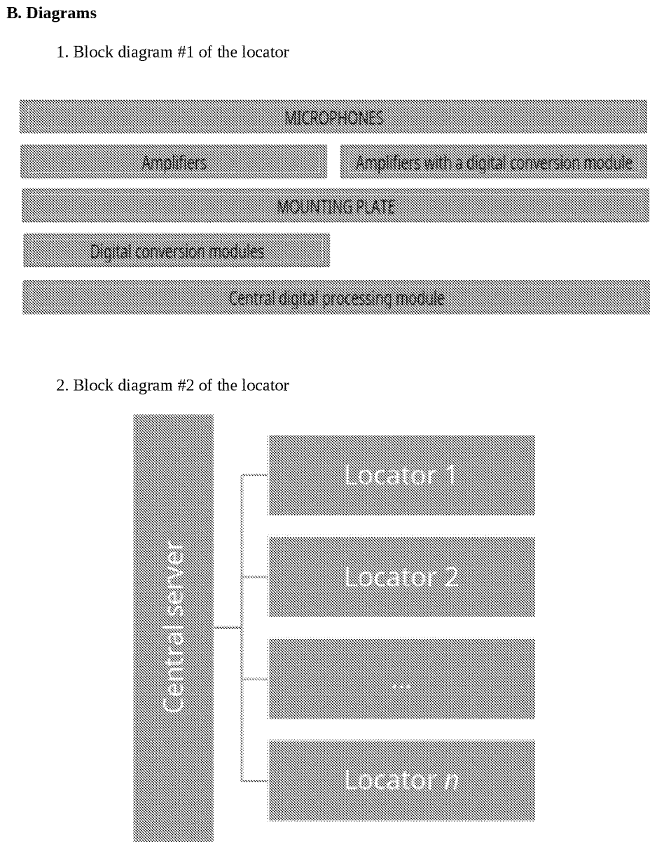

FIG. 2—a schematic representation of an example arrangement of microphones in the directional microphone array of the acoustic detection, recognition, and localization device for airborne targets, with applied amplification coefficients;

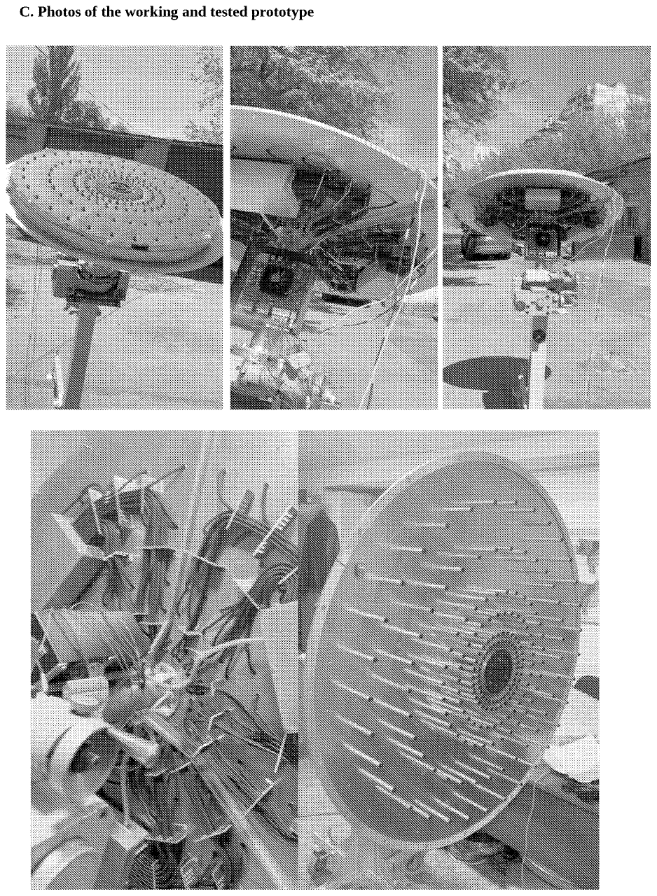

FIG. 3—an example of a radiation pattern diagram of the directional microphone array of the acoustic detection, recognition, and localization device for airborne targets (projection onto the horizontal plane).

Preliminary calculations are performed to determine the time delays of the acoustic signal arrival at each microphone of the directional microphone array, as well as to compute the optimal amplification coefficients for each microphone of the directional microphone array and each frequency or frequency interval. These coefficients are selected to minimize both the main and side lobes of the radiation pattern, as illustrated below.

### Mathematical Model of the Directional Microphone Array

Let the microphone array consist of M microphones located at points M₁ (x₁, y₁), M₂ (x₂, y₂), . . . , M_{M} (x_{M}, y_{M}), respectively. Let

$$R = {max}_{m} \vert {M}_{m} \vert$$

denote the radius of the microphone array. Consider a modified spherical coordinate system, in which, for convenience, we replace θ with its complementary angle

$$\frac{π}{2} - θ .$$

### Optimization of the Radiation Pattern

Fix a certain frequency v and let s be a sinusoid of this frequency, i.e., s (t)=sin (2πvt). Denote by tₘ (φ, θ) the time it takes for a plane sound wave from a distant sound source in the direction (φ, θ) to travel from the boundary of the circular microphone array to the microphone Mₘ, i.e.

$${t}_{m} ( φ , θ ) = \frac{R - ( {x}_{m} cos φ + {y}_{m} sin φ ) cos θ}{c} ,$$

where c represents the speed of sound. Assume that a sound signal s arrives from the main direction (φ₀, θ₀). Denote by Δtₘ (φ, θ) the time difference between the arrival of signals from the direction (φ, θ) and the main direction, i.e.,

Δtₘ(φ,θ)=tₘ(φ,θ)−tₘ(φ₀,θ₀).

Assign each microphone Mₘ an amplification coefficient aₘ∈[0,1] such that a₁+a₂+ . . . +a_{M}=1. Define the recorded signal of the directional microphone array in the direction (φ, θ) as

$${r}_{φ , θ} ( t ) = {\sum }_{m = 1}^{M} {a}_{m} s ( t - Δ {t}_{m} ( φ , θ ) ) .$$

Define the radiation pattern as the amplitude of the recording, i.e.,

$$P ( φ , θ ) = {max}_{t} {r}_{φ , θ} ( t ) V .$$

The optimal collection of amplifications a=(a₁, a₂, . . . , a_{M}) is defined as the solution to the optimization problem

$$arg {min}_{a} {\int }_{0}^{π} φ P ( φ , {θ}_{0} ) d φ .$$

### Mathematical Model of a Directional Microphone

Let each microphone Mₘ in the microphone array records its discrete sound signal sₘ=(sₘ₁, sₘ₂, . . . , s_{mN}) of length N with a sampling rate D. Perform a discrete Fourier transform (DFT) on each signal sₘ to obtain its spectrum Sₘ=(Sₘ₁, Sₘ₂, . . . , S_{mN}). For each frequency

$${v}_{k} = \frac{Dk}{N} ,$$

compute the set of optimal amplification coefficients aₖ₁, aₖ₂, . . . , a_{kM}. The spectrum of the directional microphone recording in the main direction (φ₀, θ₀) is defined as the collection of complex numbers

$$R ( {φ}_{0} , {θ}_{0} ) = {R}_{k} ( {φ}_{0} , {θ}_{0} ) = \frac{1}{M} {\sum }_{n = 1}^{N} {\sum }_{m = 1}^{M} {a}_{k m} {S}_{mn} {e}^{i 2 π \frac{Dk}{N} {t}_{m} ( {φ}_{0} , {θ}_{0} )} .$$

The recording of the directional microphone in the main direction (φ₀, θ₀) is defined as the discrete signal r(φ₀, θ₀), which is the inverse discrete Fourier transform (IDFT) of R(φ₀, θ₀).

### Example of a Directional Microphone Array and Radiation Pattern

Consider a planar directional microphone array consisting of N=248 microphones arranged as shown in FIG. 1.

For example, choose the main direction (φ₀, θ₀)=(0,0) and frequency v=500 (Hz). By optimizing the radiation pattern using the described procedure, we obtain the optimal collection of amplification coefficients a and the radiation pattern P. In FIG. 2, the optimal collection of amplification coefficients is shown (where points with more intense color correspond to higher amplification coefficients). FIG. 3 displays the horizontal radiation pattern P(φ, 0).

The average attenuation of the radiation pattern amplitude of the directional microphone array outside the main lobe of the specified pattern is approximately −55 dB, which ensures significant suppression of noise coming from directions other than the main one. The projection area of the radiation pattern onto the horizontal plane is approximately 1/10 of the total circle area, which is equivalent to increasing the potential target detection range by more than 3 times due to the directivity effect.

The operation of the acoustic detection, recognition, and localization device for airborne targets is carried out as follows.

Acoustic signals emitted by potential airborne targets are received by the directional microphone array, which is configured for their simultaneous and continuous conversion into electrical signals. These signals are amplified using preamplifiers. The electrical signals are then transmitted to the corresponding digital conversion modules, where analog-to-digital converters (ADCs) amplify each signal by a predefined number of times. At the same time, a synchronization pulse is received, allowing synchronization across all channels. Each ADC channel maintains an individually pre-set delay within the sampling interval, provided that this delay is not set to zero. All ADC channels, either in order of increasing delay or simultaneously if the delay is the same for all channels, perform digitization of the received signals (after amplification). This is done by converting voltage values into integers corresponding to the number of ADC quantization intervals. As each ADC completes its measurements, the digital values are transferred via available serial interfaces into the operational memory of the digital conversion module. Each digital conversion module waits for all data from all ADCs to be read. The digital conversion module then forms a data block and, depending on the configuration, either accumulates the required number of data blocks before transmitting them to the central computing module via a hub or transmits them directly to the central computing module without waiting.

As the central computing module receives data blocks, it stores them in an array in the operational memory in chronological order. The processor of the central computing module, utilizing mathematical algorithms optimized for linear algebra hardware through parallel multiprocessor computations, is configured to perform the Fourier transform for each data stream corresponding to each microphone of the directional microphone array.

The processor of the central computing module is additionally configured to use a precomputed array of amplification coefficients for each microphone of the directional microphone array and each frequency or frequency interval. This is done to form an optimal radiation pattern for the subsequent determination of airborne target parameters in such a way that it corresponds to different azimuthal and vertical angles while producing radiation patterns with absent or minimized sidelobes. The specified precomputed array of amplification coefficients for each microphone in the directional microphone array consists of 248 coefficients, calculated individually for each direction (approximately 64 directions) and each frequency (approximately 4,000 frequencies).

To process the received data, the processor of the central computing module is additionally configured to implement a self-learning neural network algorithm. The neural network simultaneously analyzes all incoming data and detects the type and model (or group of models) of targets. When a target is detected, the central computing module, using statistical algorithms and, if necessary, adjusting ADC settings, determines the type and model (or group of models) of the target, the azimuth angle and its derivative, the vertical angle and its derivative, the projection of the target's velocity onto the axis passing through the target's position and the device along with its derivative, the timestamp accounting for delays in data acquisition and processing, the wind speed and direction at the installation location of the directional microphone arrays, and the error estimation for each determined parameter.

As the central computing module generates target parameters, it transmits this data to an external consumer, such as a central server, which contains at least one processor configured to generate targeting data based on the received airborne target parameters and subsequently transmit them to an air defense system. The targeting data is selected from a group that includes the type and model (or group of models) of the target, geographical coordinates, altitude, direction of movement, speed, timestamp at which these coordinates were calculated, and the error estimation for each targeting parameter.

Using statistical and analytical methods, the central server filters out false targets that may appear in the system during a massive air raid or bombardment. The central server then transmits the information to the air defense system. If there is only one device in the system, the information is transmitted to the air defense system either through the central server or directly from the device.

If necessary, the central server sends a command to each claimed device to perform calibration according to a predefined time sequence. All devices either synchronously or sequentially emit an acoustic test signal or a set of acoustic test signals, which are used to calibrate the entire system. Each device receives signals from other similar devices and refines the actual average speed of sound, as well as the averaged values of wind speed and direction. Each device also receives its signal reflected from obstacles (such as buildings) and updates the acoustic obstruction map, forming an echo profile of the environment in a three-dimensional model.

Thus, the developed acoustic detection, recognition, and localization device for airborne targets is designed to achieve a technical result that includes increasing the detection range of airborne targets, enhancing resistance to acoustic interference/noise, improving target detection reliability, and minimizing false positives.

### APPENDIX

A. Figures
B. Diagrams
C. Photos of the working and tested prototype

1. A device for acoustic detection, recognition, and localization of airborne targets, comprising:
at least one directional microphone array configured to receive acoustic signals emitted by potential airborne targets and convert them into electrical signals, containing an array of microphones arranged in a predefined spatial configuration;
digital conversion modules connected to the microphones of the directional microphone array, designed to receive electrical signals and convert them into digital signals; and
a central computing module configured to receive data from the digital conversion modules, containing at least one processor configured to process the received data, classify the acoustic signals received by the directional microphone array by airborne target types, and determine the parameters of airborne targets for an external consumer,
characterized in that for processing the received data, at least one processor of the central computing module is additionally configured to use a precomputed array of amplification coefficients for each microphone of the directional microphone array and for each frequency or frequency interval.

2. The device according to claim 1, is characterized in that the amplification coefficients have positive values.

3. The device according to claim 1, is characterized in that the amplification coefficients have negative values.

4. The device according to claim 1, is characterized in that for processing the received data, at least one processor of the central computing module is additionally configured to implement a self-learning neural network algorithm.

5. The device according to claim 1, is characterized in that the directional microphone array contains between 16 and 65,535 microphones.

6. The device according to claim 5, is characterized in that the microphones of the directional microphone array are arranged in a radially symmetrical pattern within a circle with a diameter of 1 meter.

7. The device according to claim 1, is characterized in that it is designed to support wired or wireless communication with at least one external consumer of the determined airborne target parameters.

8. The device according to claim 1, is characterized in that the airborne target parameters are selected from a group that includes the type and model of the target; azimuth angle and its derivative; vertical angle and its derivative; projection of the target's velocity onto the axis passing through the target's position and the device, and its derivative; timestamp accounting for delays in data acquisition and processing; wind speed and direction at the installation location of the device; and an error estimation for each determined parameter.
